(19) United States
(12) Patent Application Publication
(10) Pub. No.: US 2004/0099611 A1
(43) Pub. Date: May 27, 2004

(54) Porous filter comprising gamma-phase alumima and process for manufacture

(76) Inventors: Rudolph A. Olson III, Hendersonville, NC (US); Patricia K. Steppe, Hendersonville, NC (US)

Correspondence Address: Joseph T. Guy, Ph.D, Nexsen Pruet Jacobs & Pollard, LLC, PO Drawer 10648, Greenville, SC, 29603-0648, US

(21) Appl. No.: 10/715,173

(22) Filed: Nov. 17, 2003

Related U.S. Application Data
(60) Provisional application No. 60/427,158, filed on Nov. 18, 2002.
(60) Provisional application No. 60/479,654, filed on Jun. 19, 2003.

(51) Int. Cl. B01D 39/00

(52) U.S. Cl. 210/767; 210/506; 210/510.1

(57) ABSTRACT

A process for forming an open cell alumina filter, the filter formed thereby and a method of filter using the filter. The process comprising the steps of forming a ceramic slurry comprising hydrated alumina, selected from bauxite and aluminum hydroxide, and ammonia stabilized colloidal silica. Voids are formed in the ceramic precursor slurry by an organic material to form a wet body. The wet body is heated to a temperature above a volatilisation temperature of the organic material but less than 1250° C. to form a green ceramic. The green ceramic is heated to a temperature of less than 1250° C. to form the open cell alumina filter. The alumina is γ-phase alumina.

### RELATED APPLICATIONS

The present application claims priority to U.S. Provisional Appl. No. 60/427,158, filed Nov. 18, 2002 and U.S. Provisional Application No. 60/479,654 filed Jun. 19, 2003 both or which are pending.

### BACKGROUND OF THE INVENTION

The present invention relates to a porous filter comprising predominantly γ-phase alumina and a process for manufacturing the filter.

Silica-bonded alumina open cell porous filters are well known in the art of filter technology. These filters are typically manufactured by either impregnating the pores of a porous organic foam with a ceramic precursor (known in the art as the “sponge replication technique”) or by incorporating an organic material, such as polyurethane spheres, into a ceramic precursor. In the sponge replication technique, the slurry is forced into the voids of the organic foam and dried as known in the art. The organic foam is vaporized and the slurry is fired to form a ceramic near replica of the organic foam. The voids within the ceramic struts correspond to the space originally occupied by the precursor organic foam. The remaining ceramic precursor is fired at a temperature of at least about 1250° C. whereby the alumina is predominantly in the α-phase.

The ceramic precursor typically employs sodium stabilized colloidal silica and alumina. The resulting filter element retains sodium within the ceramic as a glass modifying agent, as the colloidal silica transforms to glass during the firing process along with the sodium. It is well known that this silica-bonded alumina filter composition is not suitable for use in aqueous environments sensitive to solubilized silica and sodium (e.g. fishtanks) due, in part, to the continuous leaching of silica and sodium from the glass into the aqueous phase. Sodium is leached from sodium silicate glass relatively easily, and this process enhances the release of silica as well. In fishtanks, when the concentration of silica becomes too high, diatoms begin to grow in the system, feeding on the silica. This growth creates a brown, cruddy film that coats everything in the fishtank, which is very undesirable. In addition, certain aquatic animals, such as clams and sea anemones, are very sensitive to the concentrations of certain chemical species in the fishtank. If these concentrations get too high they will close up and possibly die. For this reason, silica-bonded alumina filters have never been considered desirable as a filter for aqueous materials except in those rare instances where leaching of sodium and silica is acceptable.

Sintered alumina filters would work well in aqueous environments sensitive to solubilized silica and sodium, as very little sodium and silica are present in such a filter, and the sintered alumina is very insoluble. A detriment to the use of sintered alumina filters in aqueous environments is the high cost as they demand firing temperatures in excess of 1500° C. and much longer firing cycles in comparison to silica-bonded alumina, typically 2-3 days compared to 2-3 hours. These aqueous systems typically demand low cost products. Sintered alumina filters have not met this limitation and have therefore met with limited success.

Bauxite is a low cost source of alumina because it is a mineral. A potential application of silica-bonded alumina filters is as a support in biologicial systems wherein bacteria are allowed to grow on the support. Certain bacteria oxidize ammonia to, for example, nitrates and nitrites in a first step and then certain bacteria reduce the oxides to nitrogen gas and hydrogen gas. The second step in this process is typically referred to in the art as denitrification. High surface area is preferable for systems of this nature.

Alumina in the α-phase has a relatively low surface area and low surface reactivity and is therefore less than desirable in these systems. Alumina filters comprising α-phase alumina are considered to be inferior in these systems.

The art has been desirous of an alumina based filter system for use in aqueous systems which is economical to manufacture, has a highly reactive surface, a high surface area and which is not susceptible to leaching. This desire has previously not been met. This desire is now met by the present invention.

### BRIEF SUMMARY OF THE INVENTION

It is an object of the present invention to provide an alumina-based filter suitable for use in aqueous environments, particularly aqueous biological environments, without the detrimental leaching of sodium and silica.

It is another object of the present invention to provide an alumina-based filter which can be prepared at lower cost. Particularly, a process for forming filters from bauxite or aluminum hydroxide and bonding the alumina at low temperature with colloidal silica is provided.

It is yet another object of the present invention to provide a porous ceramic filter comprising predominantly γ-phase alumina, thereby providing increased surface area and increased surface reactivity relative to α-phase alumina.

A particularly preferred object of the present invention is to provide a filter structure which is easily manufactured at a low cost and which has a highly reactive surface with high surface area. The properties and economical availability of this filter provides a substrate which will be suitable for many diverse applications.

These and other advantages, as would be realised to one of ordinary skill in the art, are provided in an open cell alumina filter comprising at least about 80%, by weight, γ-phase alumina

Another embodiment is provided in a process for forming an open cell alumina filter. The process comprising the steps of forming a ceramic slurry comprising hydrated alumina, selected from bauxite and aluminum hydroxide, and ammonia stabilized colloidal silica. Voids are formed in the ceramic precursor slurry by an organic material to form a wet body. The wet body is heated to a temperature above a volatilisation temperature of the organic material but less than 1250° C. to form a green ceramic. The green ceramic is heated to a temperature of less than 1250° C. to form the open cell alumina filter.

Yet another embodiment is provided in a method for filtering a medium comprising passing the medium through an alumina filter wherein the filter comprises alumina and the alumina comprises at least about 80%, by weight, γ-phase alumina.

### DETAILED DESCRIPTION OF THE INVENTION

The inventors of the present application have developed, through diligent research, an improved filter particularly suitable for aqueous biological environments which has a reactive, high area surface, can be manufactured at a low cost, and water does not leach out detrimental chemical species to high concentrations, such as sodium and silica, when passing there through.

The slurry employed for the present invention comprises bauxite and ammonium stabilized colloidal silica. The slurry is preferably an aqueous suspension with a relatively high degree of fluidity. The ceramic precursor preferably comprises about 50 to about 70%, by weight bauxite or aluminum hydroxide and about 5-25%, by weight, ammonium stabilized colloidal silica with the balance being water and adjuvants. It is typically desirable to add adjuvants such as surfactants, wetting aids, thickening agents, mineral colloid, etc. More preferably, the ceramic precursor comprises about 55-60%, by weight, bauxite and about 15-20%, by weight, ammonium stabilized colloidal silica.

It is necessary to stabilize silica with a base. When sodium salts, such as sodium hydroxide, are utilized the sodium is maintained in the ceramic as a non-volatised material. With ammonium stabilized colloidal silica ammonia and water of hydration are volatilised during the firing process. The result is the removal of the stabilizing salts thereby eliminating the ability of water to leach the salts from the finished article. This allows the silica-bonded alumina filter to be usable in aqueous environments, particularly biological environments, where leaching of chemical species to high concentration is detrimental to the environment.

Bauxite is a very low cost, crystalline, aluminum oxide based, low solubility material which with a silica-based binder allows for firing at relatively low temperature while still providing a strong, glassy bond. The silica binder is preferably colloidal silica, which is stabilized with ammonium. The introduction of alkalis to silica-based glass increases the solubility and the rate at which silica and alkalis are released to the environment. The use of ammonium stabilized colloidal silica provides a strong glassy bond between particles of alumina, allowing the articles to be manufactured at relatively low temperatures and short firing schedules while reducing the solubility of the glass matrix in water.

Bauxite is a mineral composed of a mixture of gibbsite, Al(OH)₃, diaspore and boehmite. Diaspore and boehmite both have a stoichiometry of HAlO₂ but they have different crystalline form. Gibbsite, diaspore and boehmite are all hydrated forms of alumina. When hydrated alumina decomposes to alumina at 300° C., it transforms to γ-phase alumina. γ-phase alumina is a very fine grained, relatively high surface area material, which has higher reactivity than α-phase alumina. γ-phase alumina transforms to α-phase alumina at about 1250° C., at which point the grains coarsen and the surface area is significantly reduced. Because the composition presented here is glass-bonded and can be fired at temperatures below about 1250° C., the transformation of alumina from the γ-phase to the α-phase is avoided and the high surface area and higher reactivity of the γ-phase alumina is maintained. In the aqueous environment, the high surface, area alumina may act to react with, and retain, any solubilized silica and further inhibit the release of silica to the aqueous environment, preventing the formation of diatoms.

Synthetic aluminum hydroxide may also be used in place of bauxite, as it is also a form of hydrated alumina, which when heated beyond 300° C. will completely convert to γ-phase alumina. Bauxite is preferred over aluminum hydroxide.

Ceramic filters are known in the art to be prepared by either a foam replication technique or a sphere incorporation technique.

In preparing a ceramic filter by the foam replication technique, foam is impregnated with ceramic slurry. The ceramic slurry is then dried, the foam is vaporized and the ceramic is sintered. The process for forming a ceramic filter by foam replication is provided in U.S. Pat. Nos. 4,056,586; 5,456,833 and 5,673,902 all of which are incorporated herein by reference thereto.

In the foam replication technique, a flexible foam material is impregnated with the aqueous ceramic slurry so that the fiber-like webs are coated therewith and the voids are filled therewith. Normally, it is preferred to repeatedly immerse the foam in the slurry and to compress the foam between immersions to insure complete impregnation of the foam.

The impregnated foam is compressed to expel from 25 to 75% of the slurry while leaving the fiber-like web portion coated therewith. In a continuous operation one may pass the impregnated foam through a preset roller to affect the desired expulsion of slurry from the foam and leave the desired amount impregnated therein. This may be done manually by simply squeezing the flexible foam material to the desired extent. At this stage, the foam is still flexible and may be formed into configurations suitable for specific filtration task, i.e., into curved plates, hollow cylinders, etc. It is necessary to hold the formed foam in position by conventional means until the organic substrate is decomposed, or preferably until the ceramic is sintered. The impregnated foam is then dried by either air drying or accelerated drying at a temperature of from 35° to 700° C. for from 15 minutes to 6 hours. Air drying may be achieved in from 8 to 24 hours. After drying, the material is heated at an elevated temperature to bond the ceramic particle making up the fiber-like webs. It is preferred to heat the dried impregnated material in two stages, with the first stage being to heat to a temperature of from 350° to 700° C. and holding within this temperature range for from 15 minutes to 6 hours in order to burn off or volatilize the web of flexible foam. Clearly this step can be part of the drying cycle, if desired. The second stage is to heat to a temperature of from 900° to no more than about 1250° C. and holding within that temperature range for from 15 minutes to 10 hours in order to bond the ceramic. The resulting product is a fused ceramic foam having an open cell structure characterized by a plurality of interconnected voids surrounded by a web of ceramic. The ceramic foam may have any desired configuration based on the configuration needed for the particular filtration process.

For the purposes of the present invention an organic foam with a pore size in the range of about 10 to about 50 pores per linear inch is most preferred.

The sphere incorporation technique is described in U.S. Pat. Nos. 6,210,612 and 6,592,787 both of which are incorporated herein by reference. In the sphere incorporation technique, a ceramic precursor is mixed with pliable organic hollow spheres in a liquid form. The article is then formed into a desired shape by pressing, slip casting, extruding or injection molding the mixture. The article is then dried to remove the liquid, and fired to remove the organic spheres and to bond the ceramic. The article is then further heated to a temperature of from 900° to no more than about 1250° C. and held within that temperature range for from 15 minutes to 10 hours in order to bond the ceramic. The pores of the ceramic correspond to those spaces previously occupied by organic spheres. The spheres are preferably a polymer, such as acrylic.

A range of porosities of up to 95% void volume may be achieved with the sphere incorporation technique. The amount and size of porosity is controlled by controlling the amount and the size range of the polymer sphere used. The preferred range for the size of the organic spheres is between 1 micron and 1000 microns. The distribution of the pores in the article is highly uniform due to the fact that the polymer spheres and the article are preferably simultaneously suspended by the addition of the appropriate suspending agent.

The heating cycle for the present invention is necessarily maintained at below about 1250° C. Above about 1250° C., the γ-phase of alumina converts to the α-phase of alumina. The α-phase of alumina has a lower surface area and lower surface reactivity and is therefore less desirable than the γ-phase of alumina.

It is most preferred that the alumina of the filter comprise at least 80%, by weight, γ-phase alumina with other phases being maintained below about 20%, by weight. More preferably, the alumina content of the filter comprises at least about 90%, by weight, γ-phase alumina. Most preferably, the alumina content of the filter comprises essentially of γ-phase alumina.

Total exclusion of leachable species, such as sodium, is impractical in standard operating conditions with readily available starting materials. While it is desirable to totally eliminate leachable species, a practical limitation is that the amount of leachable species be less than 1%, by weight, of the total ceramic filter. More preferably, the sodium is present in an amount of less than 1%, by weight. More preferably, the leachable species are present in an amount of less than 0.1%, by weight and most preferably, the sodium is present in an amount of less than 0.1%, by weight.

Leachable species are elements with a sufficient solubility in the medium of use to be detectable in the environment of use excluding other sources of the same element. The most preferred medium is water with the environment being used as either a filter or as a growth medium for bacteria of interest.

The filters of the present invention are suitable as filters and as substrates for a breeding ground for denitrification bacteria and ammonium oxidation bacteria for use in aqueous media.

A slurry comprising about 54 lbs of −325 mesh bauxite, purchased from CE Minerals, about 1 lb bentonite, about 21 lbs of fumed silica, about 10 lbs of ammonia stabilized colloidal silica, about 0.022 lbs of aquathix as a thickener, and about 14 lbs of water was prepared. An organic foam with a pore size of 40 pores per linear inch was impregnated with the slurry in a conventional manner. The ammonia, water of hydration and foam were removed and the ceramic was fused by heating up to about 1185° C. for 30 minutes. The resulting filter was sufficiently strong to be handled and placed into a filtration apparatus.

A slurry comprising about 54 lbs of −325 mesh mullite, purchased from CE Minerals, about 1 lb bentonite, about 21 lbs of fumed silica, about 10 lbs of ammonia stabilized colloidal silica, about 0.022 lbs of aquathix as a thickener, and about 14 lbs of water was prepared. An organic foam with a pore size of 40 pores per linear inch was impregnated with the slurry in a conventional manner. The ammonia, water of hydration and foam were removed and the ceramic was fused by heating up to about 1185° C. for 30 minutes. The resulting filter was sufficiently strong to be handled and placed into a filtration apparatus.

A slurry comprising about 54 lbs of −325 mesh bauxite, purchased from CE Minerals, about 1 lb bentonite, about 21 lbs of fumed silica, about 10 lbs of sodium stabilized colloidal silica, about 0.022 lbs of aquathix as a thickener, and about 14 lbs of water was prepared. An organic foam with a pore size of 40 pores per linear inch was impregnated with the slurry in a conventional manner. The ammonia, water of hydration and foam were removed and the ceramic was fused by heating up to about 1185° C. for 30 minutes. The resulting filter was sufficiently strong to be handled and placed into a filtration apparatus.

The resulting filters were tested in a saltwater aquarium containing various species of marine life. The mullite-based filter and the bauxite-based filter bonded with sodium-stabilized colloidal silica released considerably more silica than the bauxite filter bonded with ammonium-stabilized colloidal silica. The results indicate that mullite based filters and bauxite based filters bonded with sodium stabilized colloidal silica would be detrimental to marine life. The bauxite based filter with ammonium stabilized colloidal silica is suitable for use in a marine environment. The results indicate that mullite based filters and bauxite based filters bonded with sodium stabilized colloidal silica are detrimental to marine life in a controlled environment. The bauxite based filter with ammonium stabilized colloidal silica is suitable for use in a marine environment.

The invention has been described with particular emphasis on the preferred embodiments. It would be realized from the teachings herein that other embodiments, alterations, and configurations could be employed without departing from the scope of the invention which is more specifically set forth in the claims which are appended hereto.

Claimed is:

1. An open cell alumina filter comprising at least about 80%, by weight, γ-phase alumina.

2. The open cell alumina filter of claim 1 wherein alumina is at least about 80% by weight, γ-phase alumina.

3. The open cell alumina filter of claim 2 wherein said alumina comprises at least about 90%, by weight, γ-phase alumina.

4. The open cell alumina filter of claim 3 wherein said alumina consist essentially of γ-phase alumina.

5. The open cell alumina filter of claim 1 wherein said alumina filter comprises less than about 1%, by weight leachable species.

6. The open cell alumina filter of claim 5 wherein said alumina filter comprises less than about 0.1%, by weight leachable species.

7. The open cell alumina filter of claim 5 wherein said alumina filter comprises less than about 1%, by weight sodium.

8. The open cell alumina filter of claim 7 wherein said alumina filter comprises less than about 0.1%, by weight sodium.

9. A process for forming an open cell alumina filter comprising the steps of:
forming a ceramic slurry comprising:
hydrated alumina selected from bauxite and aluminum hydroxide; and
ammonia stabilized colloidal silica;
forming voids of organic material in said ceramic precursor slurry to form a wet body;
heating said wet body to a temperature above a volatilisation temperature of said organic material but less than 1250° C. to form a green ceramic; and
heating said green ceramic to a temperature of less than 1250° C. to form said open cell alumina filter.

10. The process for forming an open cell alumina filter of claim 9 wherein said hydrated alumina is bauxite.

11. The process for forming an open cell alumina filter of claim 9 wherein said organic material is an open cell foam and said slurry impregnates voids of said open cell foam.

12. The process for forming an open cell alumina filter of claim 9 wherein said organic material comprises organic spheres.

13. The process for forming an open cell alumina filter of claim 9 wherein alumina of said filter comprises at least about 80%, by weight, γ-phase alumina.

14. The process for forming an open cell alumina filter of claim 13 wherein said alumina comprises at least about 90%, by weight, γ-phase alumina.

15. The process for forming an open cell alumina filter of claim 14 wherein said alumina consist essentially of γ-phase alumina.

16. The process for forming an open cell alumina filter of claim 9 wherein said ceramic filter comprises no more than about 1%, by weight, leachable species.

17. The process for forming an open cell alumina filter of claim 16 wherein said ceramic filter comprises no more than about 0.1%, by weight, leachable species.

18. The process for forming an open cell alumina filter of claim 16 wherein said ceramic filter comprises no more than about 1%, by weight, sodium.

19. The process for forming an open cell alumina filter of claim 18 wherein said ceramic filter comprises no more than about 0.1%, by weight, sodium.

20. The process for forming an open cell alumina filter of claim 9 wherein said slurry comprises about 50-70%, by weight hydrated alumina and about 5-25%, by weight ammonium stabilized silica.

21. The process for forming an open cell alumina filter of claim 20 wherein said slurry comprises about 55-60%, by weight hydrated alumina and about 15-20%, by weight ammonium stabilized silica.

22. A method for filtering a medium comprising passing said medium through an alumina filter wherein said filter comprises alumina and said alumina comprises at least about 80%, by weight, γ-phase alumina.

23. The method for filtering a medium of claim 22 wherein said alumina comprises at least about 90%, by weight, γ-phase alumina.

24. The method for filtering a medium of claim 23 wherein said alumina consist essentially of γ-phase alumina.

25. The method for filtering a medium of claim 22 wherein said alumina filter comprises no more than about 1%, by weight, leachable species.

26. The method for filtering a medium of claim 25 wherein said alumina filter comprises no more than about 0.1%, by weight, leachable species.

27. The method for filtering a medium of claim 25 wherein said alumina filter comprises no more than about 1%, by weight, sodium.

28. The method for filtering a medium of claim 27 wherein said alumina filter comprises no more than about 0.1%, by weight, leachable species.

29. The method for filtering a medium of claim 22 wherein said medium is an aqueous medium.
